(19) United States
(12) Patent Application Publication
(10) Pub. No.: US 2007/0053545 A1
(43) Pub. Date: Mar. 8, 2007

(54) Speaker

(76) Inventor: Steff Lin, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 11/219,681

(22) Filed: Sep. 7, 2005

(51) Int. Cl. H04R 1/00

(52) U.S. Cl. 381/397

(57) ABSTRACT

A speaker is disclosed to have a heat dissipation layer formed of a metal sleeve and downwardly extending from the bottom side of the cone paper and sleeved onto the voice coil to dissipate heat from the voice coil, preventing falling of the voice coil during the operation of the speaker.

### BACKGROUND OF THE INVENTION

1. Field of the Invention

The present invention relates to speakers and more particularly, to a durable structure of speaker that prevents falling of the sound coil.

2. Description of the Related Art

FIGS. 1 and 2 show a conventional speaker 1, which comprises a bracket 14, a T-iron 11, an annular magnet 12 supported on the T-iron 11, a washer 13 covered on the magnet 12 opposite to the T-iron 11 and fastened with the magnet 12 and the T-iron 11 to the bottom side of the bracket 14, an axle bush 161 connected to the T-iron 11, a voice coil 16 wound round the axle bush 161 and suspending in the magnet 12, and a cone paper 15 mounted on the top side of the bracket 14 and fastened to the top end of the axle bush 161. When electric current is connected to the voice coil 16 to act against the magnet 12, the cone paper 15 is driven to vibrate, thereby producing sound. During the operation of the speaker 1, the temperature of the voice coil 16 is high, and the high temperature may cause the voice coil 16 to fall from the axle sleeve 161, resulting in malfunctioning of the speaker 1. Further, due to poor heat dissipation efficiency of the voice coil 16, the output power of the speaker 1 is limited.

FIGS. 3 and 4 show another structure of speaker 2 according to the prior art. According to this design, the speaker 2 is a bi-magnet speaker, comprised of two magnets 21, washer 22, a bracket 23, a cone paper 24, an axle bush 251, and a voice coil 25. The voice coil 25 is wound round the axle bush 251, which is sleeved onto the magnet 21 and the washer 22. The cone paper 24 is mounted on the bracket 23 and fastened to the top end of the axle bush 251. This structure of bi-magnet speaker 2 has the same problem that the voice coil 25 tends to fall from the axle bush 251 during operation due to a high temperature.

### SUMMARY OF THE INVENTION

The present invention has been accomplished under the circumstances in view. It is therefore the main object of the present invention to provide a speaker, which prevents falling of the voice winding during operation, thereby improving the output power of the speaker.

To achieve this and other objects of the present invention, the speaker comprises a bracket, a washer, at least one magnet mounted with the washer in the bracket, an axle bush sleeved onto said at least one magnet and the washer, a voice coil wound round the axle bush, and a cone paper mounted on the bracket and connected to the top side of the axle bush, wherein a heat dissipation layer is provided at a bottom side of the cone paper and fastened to the periphery of the voice coil for dissipating heat from the voice coil during the operation of the speaker.

Preferably, the heat dissipation layer is a metal sleeve sleeved onto the voice coil. In one embodiment of the present invention, the metal sleeve type heat dissipation layer extends downwards from the bottom side of the cone paper and sleeved onto the voice coil. In another embodiment of the present invention, the metal sleeve type heat dissipation layer extends downwards from the bottom side of a cup, which supports the cone paper on the axle bush.

### BRIEF DESCRIPTION OF THE DRAWINGS

FIG. 1 is an exploded view of a speaker according to the prior art.

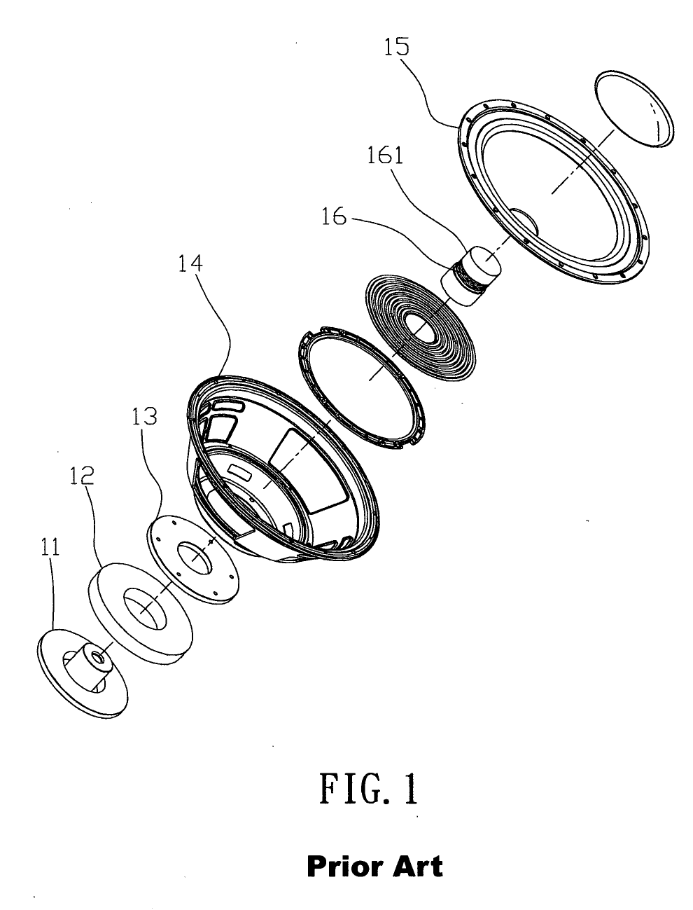

FIG. 2 is a sectional assembly view in an enlarged scale of the speaker shown in FIG. 1.

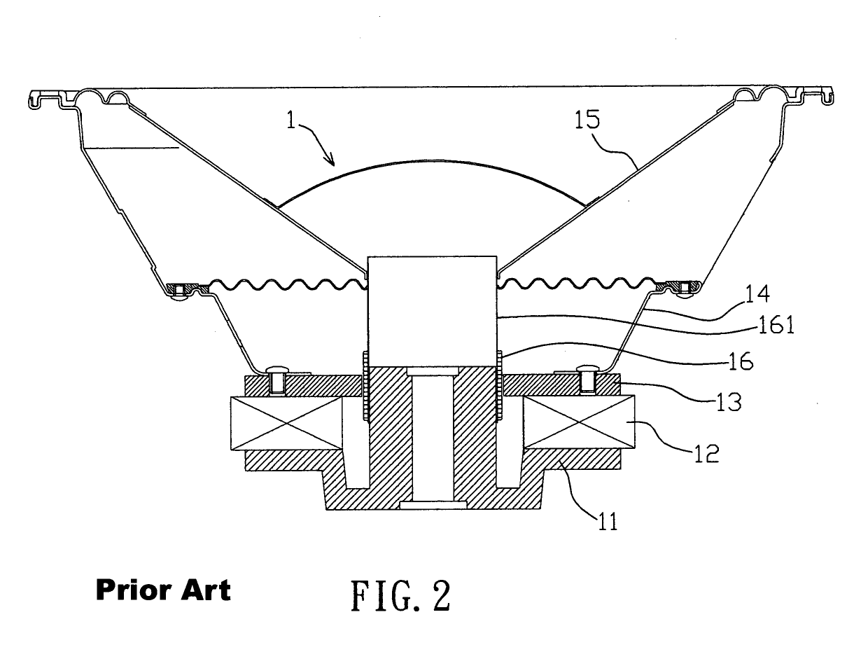

FIG. 3 is an exploded view of another structure of speaker according to the prior art.

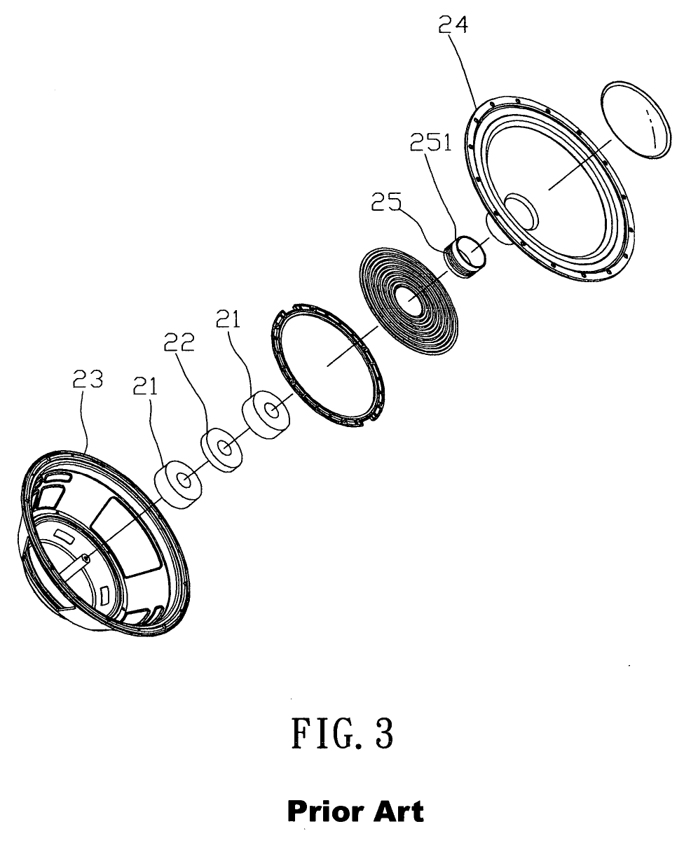

FIG. 4 is a sectional assembly view in an enlarged scale of the speaker shown in FIG. 3.

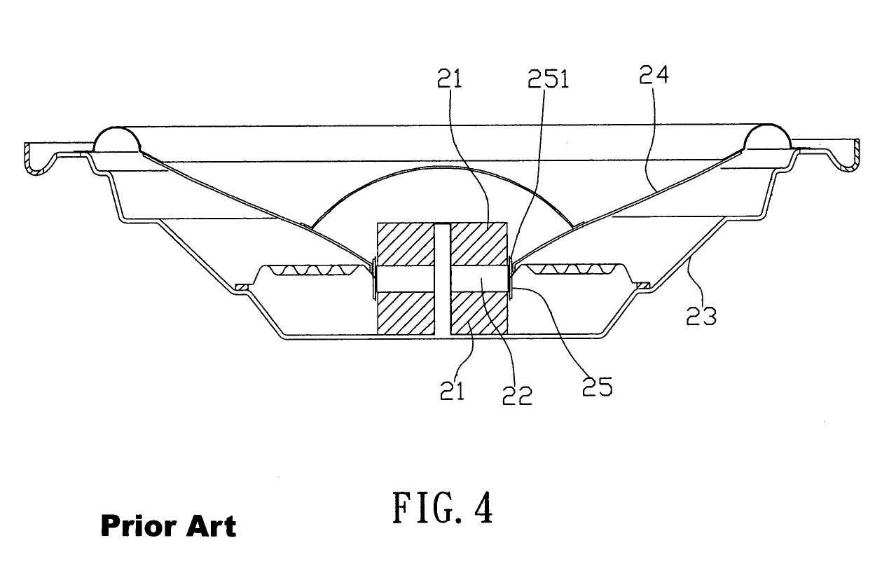

FIG. 5 is an exploded view of a speaker according to a first embodiment of the present invention.

FIG. 6 is a sectional assembly view in an enlarged scale of the speaker shown in FIG. 5.

FIG. 7 is an exploded view of a speaker according to a second embodiment of the present invention.

FIG. 8 is a sectional assembly view in an enlarged scale of the speaker shown in FIG. 7.

FIG. 9 is an exploded view of a speaker according to a third embodiment of the present invention.

FIG. 10 is a sectional assembly view in an enlarged scale of the speaker shown in FIG. 9.

FIG. 11 is an exploded view of a speaker according to a fourth embodiment of the present invention.

FIG. 12 is a sectional assembly view in an enlarged scale of the speaker shown in FIG. 11.

### DETAILED DESCRIPTION OF THE PREFERRED EMBODIMENT

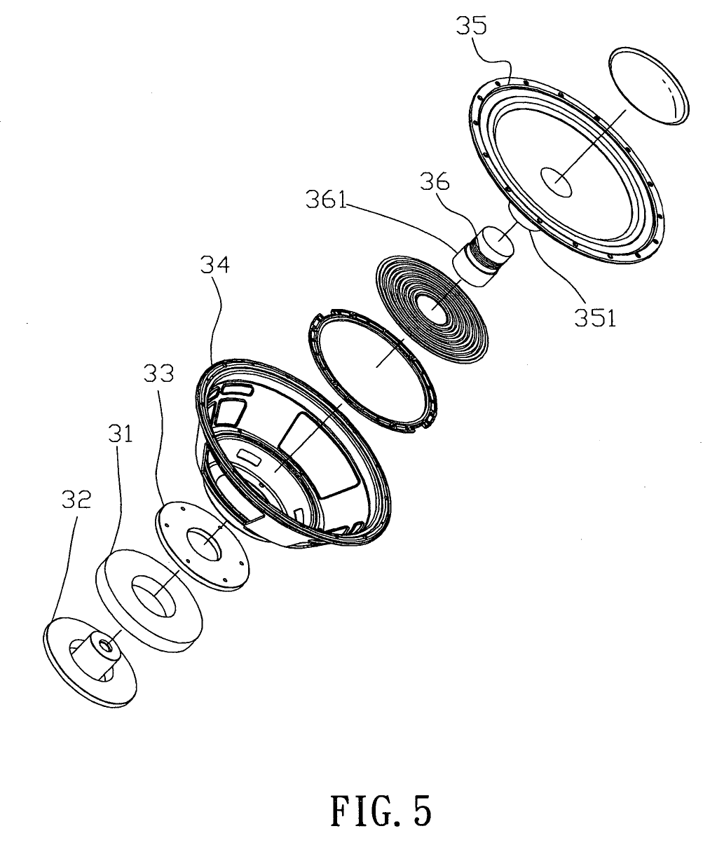

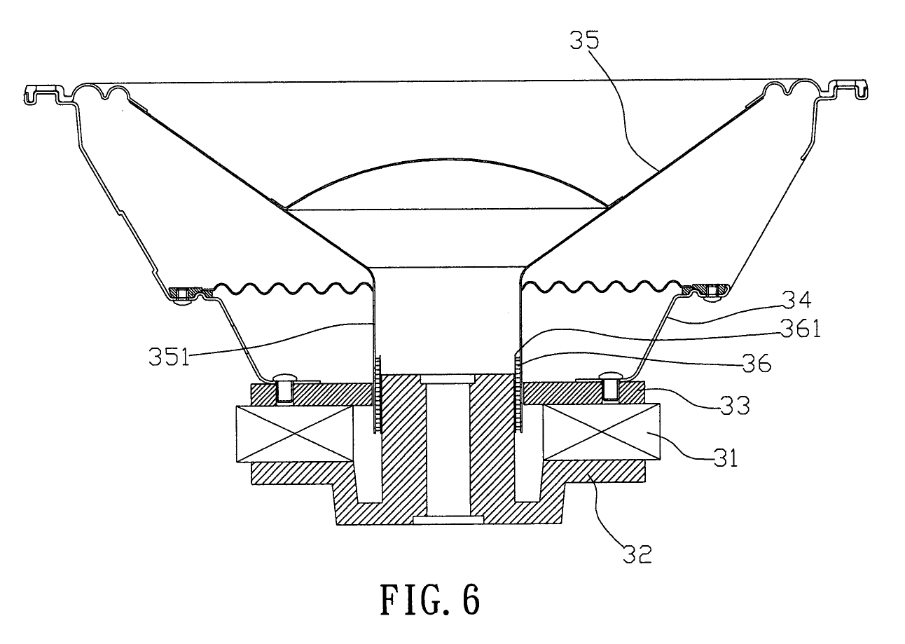

Referring to FIGS. 5 and 6, a speaker in accordance with the first embodiment of the present invention is shown comprising a bracket 34, a T-iron 32, an annular magnet 31 supported on the T-iron 32, a washer 33 covered on the magnet 31 opposite to the T-iron 32 and fastened with the magnet 31 and the T-iron 32 to the bottom side of the bracket 134, an axle bush 361 connected to the T-iron 32, a voice coil 36 wound round the axle bush 361 and suspending in the magnet 31, and a cone paper 35 mounted on the top side of the bracket 34 and fastened to the top end of the axle bush 361. Further, the cone paper 35 has a heat dissipation layer 351 provided at the bottom side and fastened to the periphery of the voice coil 36. During operation of the speaker, the heat dissipation layer 351 dissipates heat from the voice coil 36, preventing falling of the voice coil 36 from the axle bush 361.

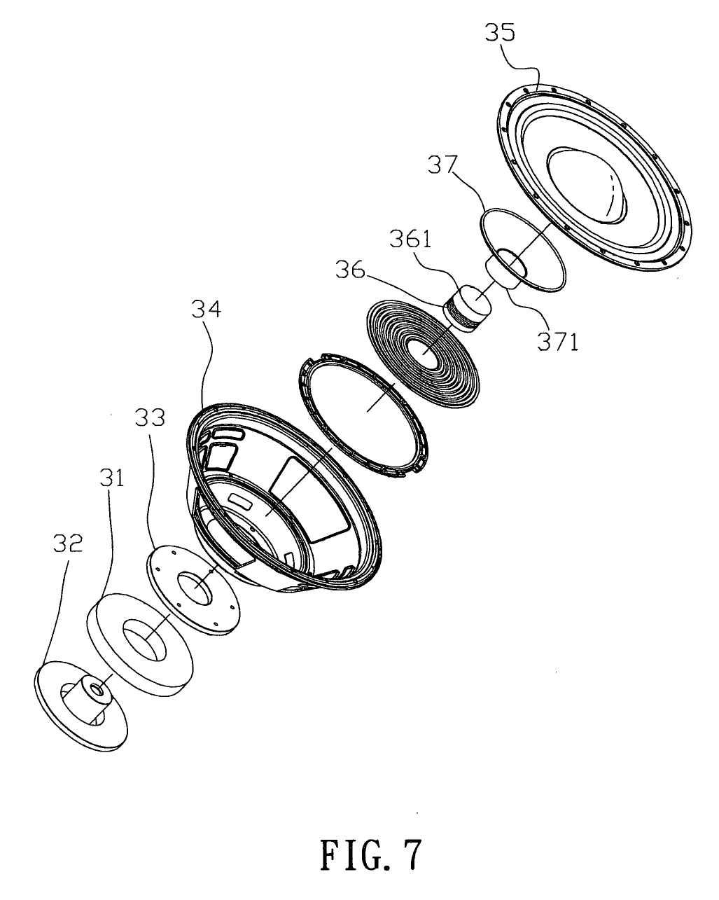

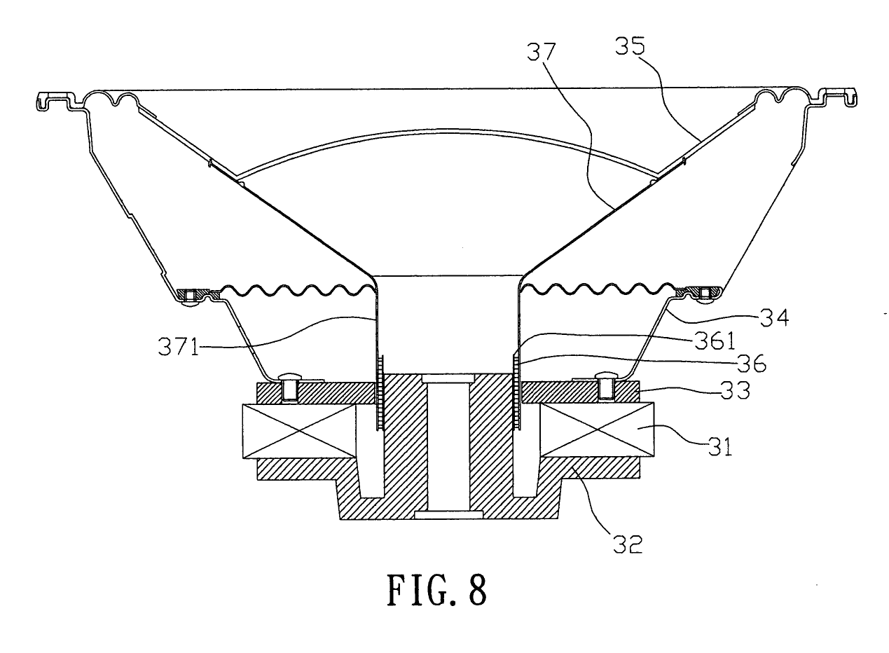

FIGS. 7 and 8 show a speaker according to the second embodiment of the present invention. This embodiment is substantially similar to the aforesaid first embodiment with the exception of the use of a cup 37 to support the cone paper 35 on the axle bush 361. The cup 37 has a heat dissipation layer 371 downwardly extending from the bottom side and fastened to the periphery of the voice coil 36.

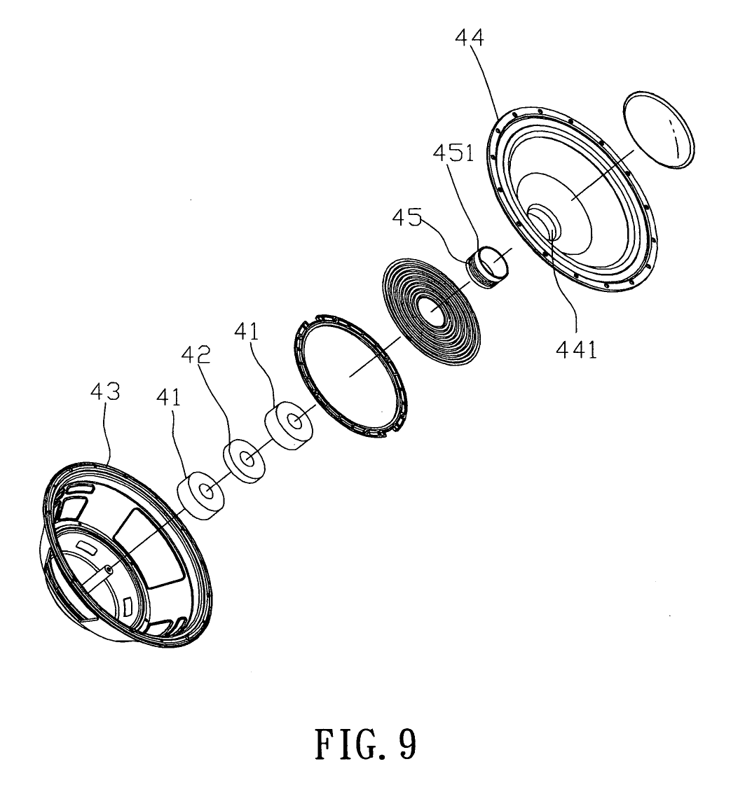

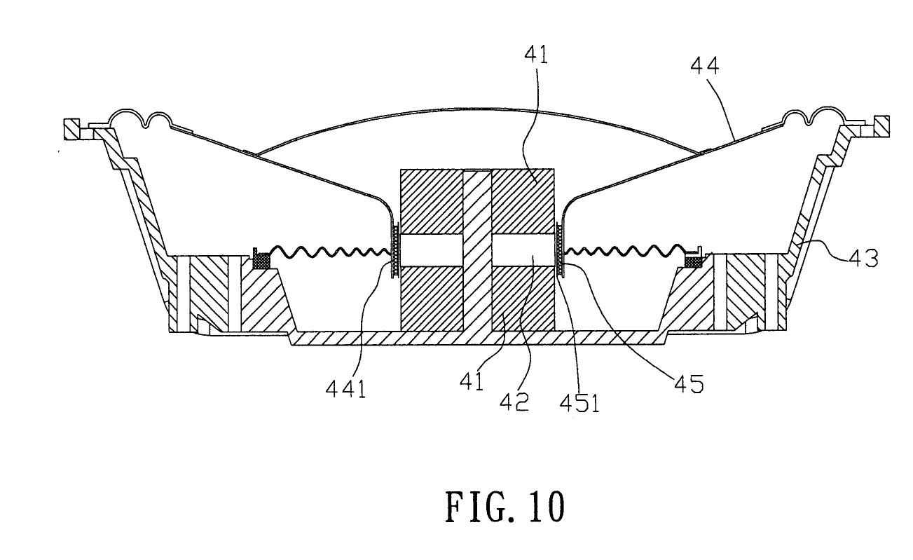

FIGS. 9 and 10 show a speaker according to the third embodiment of the present invention. According to this design, the speaker comprises two magnets 41, a washer 42 sandwiched between the magnets 41, a bracket 43 holding the magnets 41 and the washer 42, an axle bush 451 sleeved onto the magnets 41 and the washer 42, a voice coil 45 wound round the axle bush 451, a cone paper 44 mounted on the bracket 43 at the top, and a heat dissipation layer 441 provided at the bottom side of the cone paper 44 and fastened to the periphery of the voice coil 45 for dissipating heat from the voice coil 45 during the operation of the speaker.

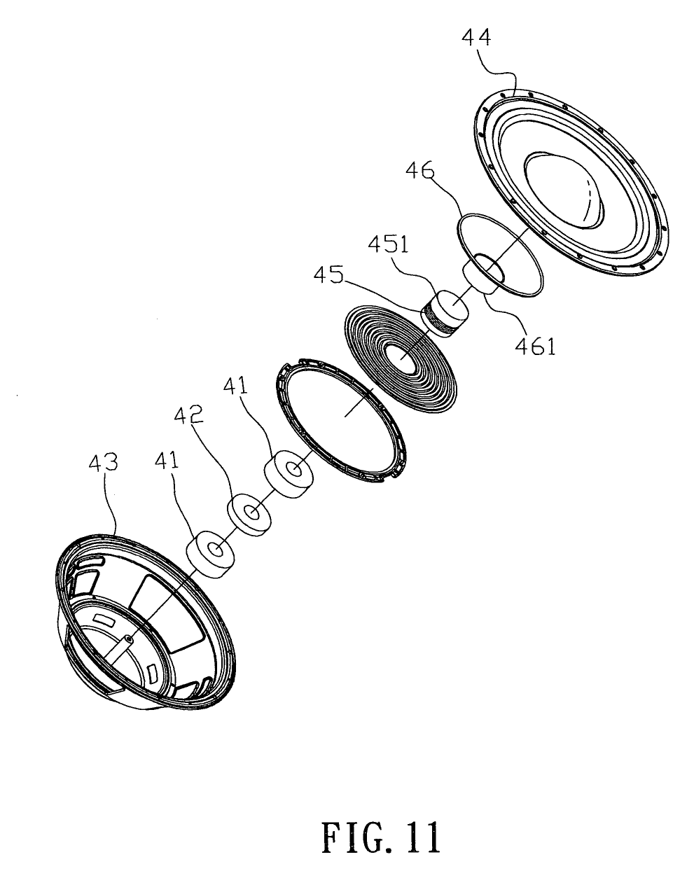

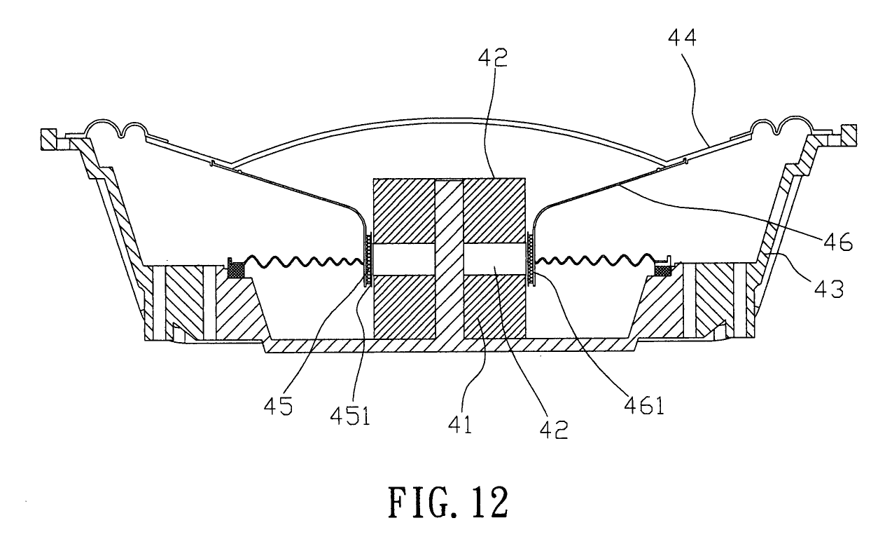

FIGS. 11 and 12 show a speaker according to the fourth embodiment of the present invention. This embodiment is substantially similar to the aforesaid third embodiment with the exception of the use of a cup 46 to support the cone paper 44 on the axle bush 451. The cup 46 has a heat dissipation layer 461 downwardly extending from the bottom side and fastened to the periphery of the voice coil 45.

In the aforesaid various embodiments of the present invention, the heat dissipation layer is a metal sleeve sleeved onto the voice coil.

A prototype of speaker has been constructed with the features of FIGS. 5˜12. The speaker functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A speaker comprising a bracket, a washer, at least one magnet mounted with said washer in said bracket, an axle bush sleeved onto said at least one magnet and said washer, a voice coil wound round said axle bush, and a cone paper mounted on said bracket and connected to a top side of said axle bush, wherein a heat dissipation layer is provided at a bottom side of said cone paper and fastened to the periphery of said voice coil for dissipating heat from said voice coil during the operation of the speaker.

2. The speaker as claimed in claim 1, wherein said heat dissipation layer extends downward from said cone paper to a predetermined distance.

3. The speaker as claimed in claim 1, wherein said heat dissipation layer has a top side fixedly fastened to a cup that supports said cone paper.

4. The speaker as claimed in claim 1, wherein said heat dissipation layer is a metal sleeve sleeved onto said voice coil.
